(19) United States
(12) Patent Application Publication
(10) Pub. No.: US 2009/0024556 A1
(43) Pub. Date: Jan. 22, 2009

(54) SEMANTIC CRAWLER

(75) Inventor: Martin Christian Hirsch, Berlin (DE)

Correspondence Address: INTELLECTUAL PROPERTY / TECHNOLOGY LAW, PO BOX 14329, RESEARCH TRIANGLE PARK, NC, 27709, US

(73) Assignee: SEMGINE, GMBH, Berlin (DE)

(21) Appl. No.: 11/778,513

(22) Filed: Jul. 16, 2007

(51) Int. Cl. G06F 17/00

(52) U.S. Cl. 706/55

(57) ABSTRACT

A method and an apparatus for extraction of information from a plurality of electronic text documents. The method comprises defining and generating a reference graph. The reference graph represents a specific theme of a reference text document. The method further comprises comparing the reference graph with a second graph using an extraction criterion. The second graph represents a specific theme of a second text document. Further, the result of the comparison is checked if the result falls within the extraction criterion boundary value. Then, the checked result of the comparison is extracted if the result falls at least within the extraction criterion boundary value. The method continues the comparison and the checking of the result of the comparison of the defined and generated reference graph with a further graph.

### CROSS-REFERENCE TO RELATED APPLICATIONS

The present application is related to the following co-pending patent application, which is assigned to the assignee of the present application and incorporated herein by reference in its entirety:

U.S. patent application Ser. No. ______ (Attorney Docket No. 4280-121), filed concurrently herewith in the name of Martin Christian Hirsch, and entitled “SEMANTIC PARSER.”

### BACKGROUND OF THE INVENTION

The present invention relates to a computer aided method and an apparatus for the extraction of information from a plurality of information sources, like electronic text documents. Each one of the electronic text documents is represented by a structural layout of a graph and a status of an element of the graph. A reference graph that represents a reference information source is compared with further graphs, i.e. further information sources. The result of the comparison is evaluated and extracted.

### BRIEF DESCRIPTION OF THE RELATED ART

Browsing a plurality of information sources, like electronic text documents, according to a methodical and automated operation strategy has become more and more important in the last few years in more and more areas of application, such as in business, science, medicine, etc. Many times, such information sources are, for example, distributed and accessible at different locations in communication networks such as intranets of companies, organizations, banks, in database systems of institutes, the Internet, etc. Frequently, further available information is needed or needs to be ascertained to existent information about a specific theme, for example, a disease and its possibilities of therapy.

To analyze, compare and extract relevant information that is widely distributed, for example, in a communication network, from further information sources, so-called “crawlers”, also known as “spiders” or “robots”, are used. Crawlers which are focused on a specific theme are also called “focused crawlers”. Crawlers for information sources that are distributed at different locations over the Internet, i.e. the World Wide Web (WWW) are often used by search engines or search services. Problems with the use of crawlers and the processing of available information in communication networks such as the Internet arise due to the large number or volume of internet sources, due to the fast change rate (flexibility) of the internet sources, i.e. the dynamic of the content of the information sources and due to the dynamic generation of further information sources and/or deletion of existent information sources. However, these features are preexisting characteristics of communication networks and can not be eliminated, because of the infrastructure and the dynamics of such an information network (also known as “dynamic content of the web”). In addition, the ranking, i.e. the index of information sources can be manipulated and thus communicate a “perverted picture” about the meaning or relevancy of an information source.

The crawlers are used in many areas of application such as validating the content of the source code of web sites, checking links to further information sources, harvesting specific information such as e-mail addresses, RSS feeds, etc. Due the characteristics of communication networks such as the Internet, crawlers can only analyze a small portion of the available information, i.e. a fraction of an information source, within a specific time limit.

It would be desirable to determine and analyze the information sources with regard to a given theme, subject or term. Such a prioritization of the information sources is realized in the prior art using specific ranking algorithms. In these ranking algorithms, the content of an information source, for example, a web site is indexed, analyzed, evaluated and stored using a rule-based system to enable, for example, searching in the collected information source.

The crawlers and their crawling strategies (e.g. breadth-first, depth-first) to index, for example, the World Wide Web are well known from the prior art. For example, the paper “Focused Crawling Using Context Graphs” (Diligenti M. et al.), 26^{th} International Conference on Very Large Databases, VLDB 2000, Cairo, Egypt, pp. 527-534, 2000 addresses the problem of performing appropriate credit assignment to different documents along a crawl path. The paper discloses a focused crawling algorithm. A focused crawler tries to identify the most promising documents in the Internet. The crawling algorithm allows users to query for web sites linking to a specific document. Data from conventional search engines such as Google™ is used to generate a representation, i.e. a context graph, of the web sites that occur within a certain link distance. The link distance is defined as the minimum number of the link transversals that is necessary to move from one web site to another. The representation is used to train a set of optimized classifiers to detect and assign documents to different categories based on the expected link distance from the reference document to the target document. In other words, the classifiers are used to predict how many steps away from a reference document the current retrieved document is likely to be.

### SUMMARY OF THE INVENTION

According to the present invention, there is provided a method for extraction of information from a plurality of information sources. Each ones of the plurality of information sources comprises at least one first information element. The at least one first information element is associated with at least one second information element. The method according to the invention comprises defining a reference graph. The reference graph represents at least a portion of a reference one of the plurality of information sources. The reference graph comprises at least one first reference node representing the at least one first information element. The at least one first reference node is associated with at least one second reference node via at least one edge. The at least one second reference node represents the at least one second information element. The at least one first reference node comprises at least one first reference node property value (which is similar to the weight of the node as disclosed in the co-pending U.S. patent application Ser. No. ______ (Attorney Docket No. 4280-121) filed in the name of Martin Christian Hirsch, and entitled “SEMANTIC PARSER”). The at least one second reference node comprises at least one second reference node property value. Subsequently the defined reference graph is compared with a second graph using at least one extraction criterion. The second graph represents at least a portion of a second one of the plurality of information sources. The at least one extraction criterion comprises at least one extraction criterion boundary value. The result of the comparison of the defined reference graph with the second graph is checked if the result falls within the at least one extraction criterion boundary value. The checked result of the comparison is extracted if the checked result falls at least within the at least one extraction criterion boundary value.

According to a second aspect of the invention, the at least one edge can comprise at least one first edge property value. The at least one extraction criterion boundary value can be in relation or associated with the at least one first edge property value.

According to a third aspect of the invention, the at least one extraction criterion boundary value can be in relation or associated with the at least one second reference node property value.

According to a fourth aspect of the invention, the method may further comprise continuing the comparison of the defined reference graph with at least one or a further graph and continuing the checking of the result of the comparison. The further graph represents at least a portion of a further one of the plurality of information sources. The checked result of the comparison of the reference graph with the at least one further graph may be extracted if the checked result falls at least within the at least one extraction criterion boundary value.

According to a further aspect of the invention, the at least one first reference node property value may comprise a frequency number. The frequency number represents the number of the at least one first information element in the reference one of the plurality of information sources.

In accordance to a further aspect of the invention, the at least one first reference node property value can comprise activation information. The activation information represents the status of the at least one first information element in the reference one of the plurality of information sources.

According to a further aspect of the invention, the method according to the invention can be a computer implemented process.

In accordance with another aspect of the invention, an apparatus is provided for extraction of information. The apparatus comprises at least one graph definition engine for defining a reference graph and generating a second graph. As already mentioned, the reference graph represents at least a portion of a reference one of the plurality of information sources and the second graph represents at least a portion of a second one of the plurality of information sources. The apparatus further comprises at least one graph comparison and checking engine for comparing the reference graph with the second graph and for checking the result of the comparison. The apparatus further comprises at least one graph information extraction engine for extracting the checked result of the comparison.

According to a further aspect of the invention, the apparatus can further comprise at least one output device for presenting the extracted checked result of the comparison.

In accordance with another aspect of the invention, there is provided a computer readable tangible medium which stores instructions for implementing the method run on a computer. The instructions control the computer to perform the process of extraction of information from a plurality of information sources as discussed previously. The computer readable tangible medium can be, for example, a floppy disk, CD-ROM, DVD, USB flash memory or any other kind of storage device. Alternatively, the instructions for implementing and executing the method according to the present invention can be downloaded via a communications networks such as intranets, the Internet, etc. In an alternative aspect of the invention, the instructions for implementing and executing the method according to the present invention can be stored on a mobile communication device with access to a communications network such as a mobile phone, etc.

In accordance with another aspect of the invention, a computer program product is provided. The computer program product is loadable into at least one memory of a computer readable tangible medium or into an electronic data processing apparatus. Such an apparatus can be, for example, an apparatus as described above. The computer program product comprises program code means to perform the extraction of information from a plurality of information sources as discussed previously.

According to another aspect of the invention, the method according to the present invention can be implemented in web browsers or linked to web browsers to assist the web browsers which have access to communication networks such as intranets, the Internet, etc.

According to a further aspect of the invention, the method according to the invention can be implemented in search algorithms of, for example, well-known search services of search-engines to improve their efficiency, quality and reliability. According to a further aspect of the invention, a search engine apparatus for executing or performing the method as discussed previously is provided other and exemplary aspects

These together with other possible and exemplary aspects and objects that will be subsequently apparent, reside in the details of construction and operation as more fully herein described and claimed, with reference being had to the accompanying figures.

It is clear for the man skilled in the art that the disclosed characteristics and features of the invention can be arbitrarily combined with each other.

### BRIEF DESCRIPTION OF THE DRAWINGS

FIG. 1 is a graphical representation of a reference information source and a reference graph, the reference graph representing at least a portion of the reference information source;

FIG. 2 is a flowchart of an example of the method according to the invention;

FIG. 3 is a scheme of an example of the method according to the invention;

FIG. 4 is a schematic representation of an example of an apparatus for performing the method according to the invention.

### DETAILED DESCRIPTION OF THE INVENTION

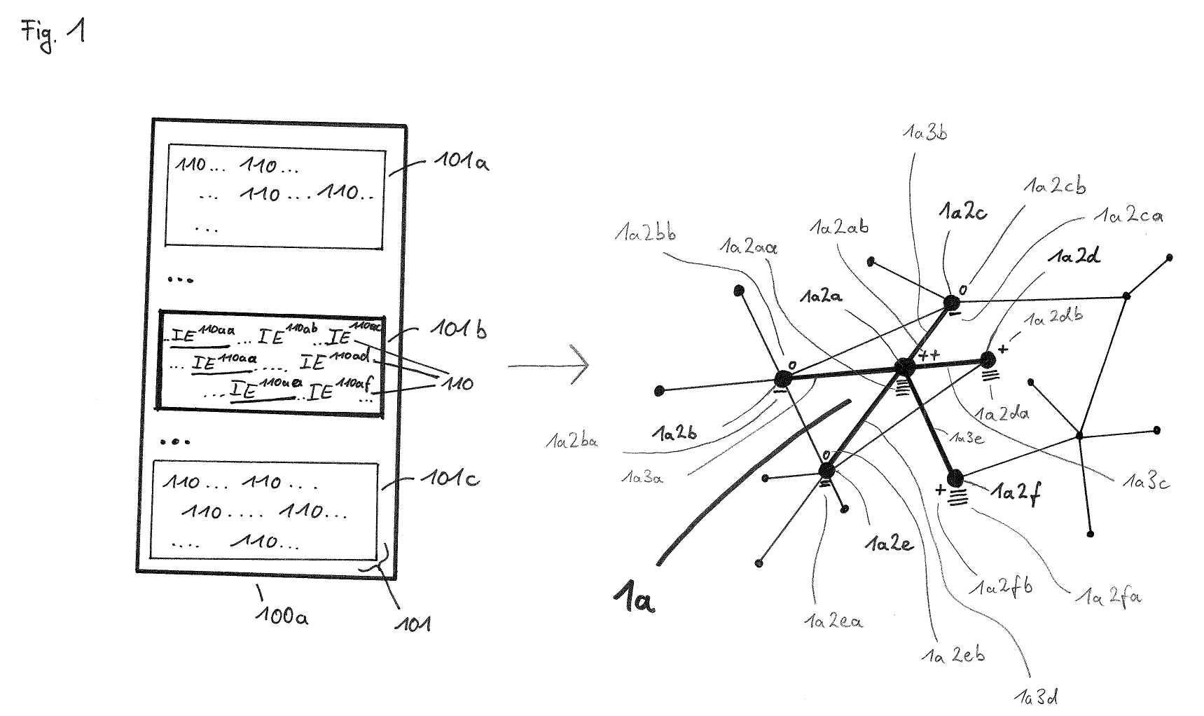

FIG. 1 shows an example of a schematically represented reference information source 100a. The reference information source 100a comprises three information portions 101a to 101c. Alternatively, the reference information source 100a can comprise a plurality of information portions 101, i.e. more than three information portions 101a-c. Each one of the plurality of information portions 101 can comprise a plurality of information elements 110 (the information elements 110 in the second information portion 101b of the reference information source 100a are exemplary termed with “IE^{110aa}”, “IE^{110ab}”, . . . ). At least one first information element IE^{110aa} is associated with at least one second information element IE^{110ab}.

The reference information source 100a can be, for example, an electronic text document, i.e. a text document that can be processed by an electronic data processing apparatus. The text document 100a may be of any kind, such as law text, scientific publications, novella, stories, newspaper articles, textbooks, catalogues, description texts, etc. The text document 100a may comprise human language text. It should be noted that the kind of the information source 100a, i.e. text document is not only limited to human language text, but can also contain computer programming language text, for example, HTTP, C, JAVA, Perl source code, etc, i.e. any other language or kind of language with a syntax, syntax elements, operators, etc.

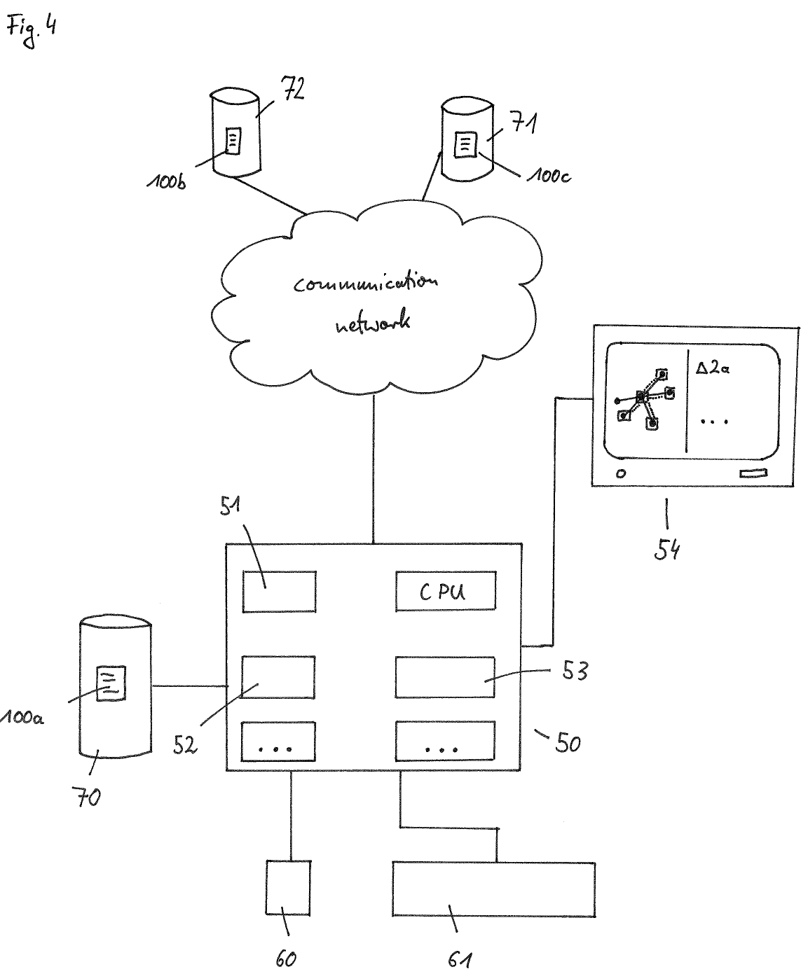

The text document 100a can be stored, for example, on a local computer and/or distributed and accessible over a communications network such as intranets, the Internet, etc, as will be discussed in FIG. 4 In an alternative aspect of the invention, an information source 100 can be, for example, an electronic picture. The electronic picture can be, for example, of JPG format, TIF format, BMP format or any other format that is able to be processed, for example, by an electronic data processing apparatus such as computer, etc. According to a further aspect of the invention, an information source 100 can be, for example, an electronic music data file or video data file or any other kind of multimedia data files. The electronic music data file can be, for example, of MP3 format, WAV format, WMA format, etc.

For example, if the information source 100a is, as already mentioned, a text document 100a of human language, each one of the information portions 101a to 101c represents a sentence or a plurality of sentences, i.e. a paragraph. In the example of FIG. 1, each one of the information portions 101a to 101c represents a paragraph containing a specific theme such as an article about sports, politics, medicine, etc. The information elements 110 can be a subject noun, i.e. a substantive, a verb, an object noun, an adjective, etc.

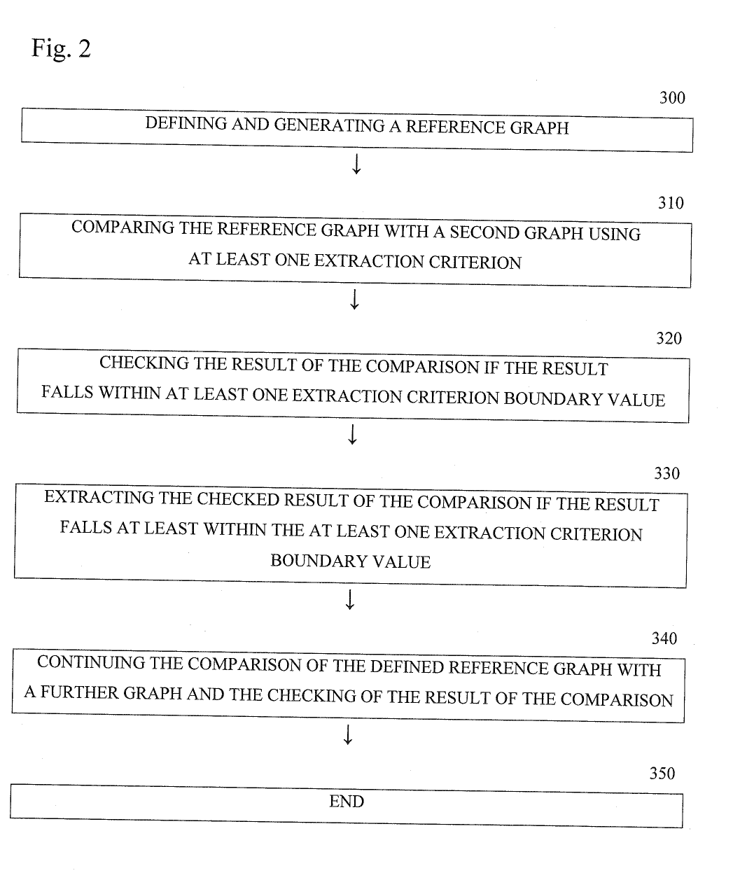

With the method according to the present invention, a reference graph 1a from the reference information source 100a, i.e. the text document 100a, is defined and generated. In particular, the reference graph 1a represents at least a portion of the text document 100a, i.e. the information portion 101b. A flowchart of an example of the method according to the invention is presented in FIG. 2. The reference graph 1a is defined by its structural layout and its status, i.e. the status of its nodes and/or edges and represents the meaning, i.e. the semantic of the paragraph 101b of the text document 100.

The reference graph 1a comprises nodes 1a2a to 1a2f. Each one of the nodes 1a2a to 1a2f is connected correspondingly to a further different one of the nodes 1a2a to 1a2f via the edges 1a3a to 1a3e. Each one of the nodes 1a2a to 1a2f is associated with or represents a single specific one of the information elements 110 (“IE^{110aa}”, IE¹¹⁰” . . . ) contained in the second information portion 101b of the reference information source 100a. Each one of the nodes 1a2a to 1a2f represents, for example, a subject noun or an object noun that is linked, i.e. associated, with a further node 1a2a to 1a2f, i.e. a further different object noun or subject noun. Each edge 1a3a to 1a3e represents, for example, a verb between corresponding information elements 110, i.e. between the subject noun and the object noun. With regard to the example of FIG. 1, node 1a2a corresponds to information element “IE^{110aa}”, node 1a2b corresponds to information element “IE^{110ab}”, node 1a2c corresponds to information element “IE^{110ac}”, etc.

Each one of the nodes 1a2a to 1a2f of the reference graph 1a has at least one node property. The at least one node property comprises at least one node property value. With regard to the example of the reference graph 1a in FIG. 1, each one of the nodes 1a2a to 1a2f comprises or is associated with two node properties with corresponding node property values.

For example, the first node 1a2a comprises or is associated with a frequency number 1a2aa. The frequency number 1a2aa is the first node property value of the first node 1a2a and represents the number of the corresponding information element 110 (“IE^{110aa}”) in the corresponding second information portion 101b. In the graphical representation of the reference graph 1a in FIG. 1, the frequency numbers 1a2aa to 1a2fa for each node 1a2a to 1a2f are graphically represented by a number of underlines beneath each of the node symbol (black filled circle) below the nodes 1a2a to 1a2f.

The first node 1a2a further comprises or is further associated with activation information 1a2ab. The activation information 1a2ab of the first node 1a2a is the second node property value and represents the status of the corresponding information element 110 (“IE^{110aa}”) of the corresponding second information portion 101b. The status information 1a2ab of the first node 1a2a, for example, characterizes that the first node 1a2a is a twice activated node (marked with at least one “+”, i.e. here with two “+”). The activation information can, for example, represent information about the location of a corresponding information element 110 (“IE^{110aa}” for node 1a2a) that is represented by a node in relation to a further location of the same corresponding information element 110 in the information portion 101b. Since the information element 110 termed with “IE^{110aa}” appears in the first three lines, this information element 110, i.e. the representing node 1a2a comprises a relatively high activation. The above presented aspects relate to the further nodes 1a2b to 1a2f correspondingly. Such characteristics can also be termed as “node weights”. In other words, the reference graph 1 is characterized by its structural layout and its status, i.e. the activation of the nodes 1a2a to 1a2f. The aspect concerning the frequency number and/or activation information can relate to the edges 1a3a to 1a3e.

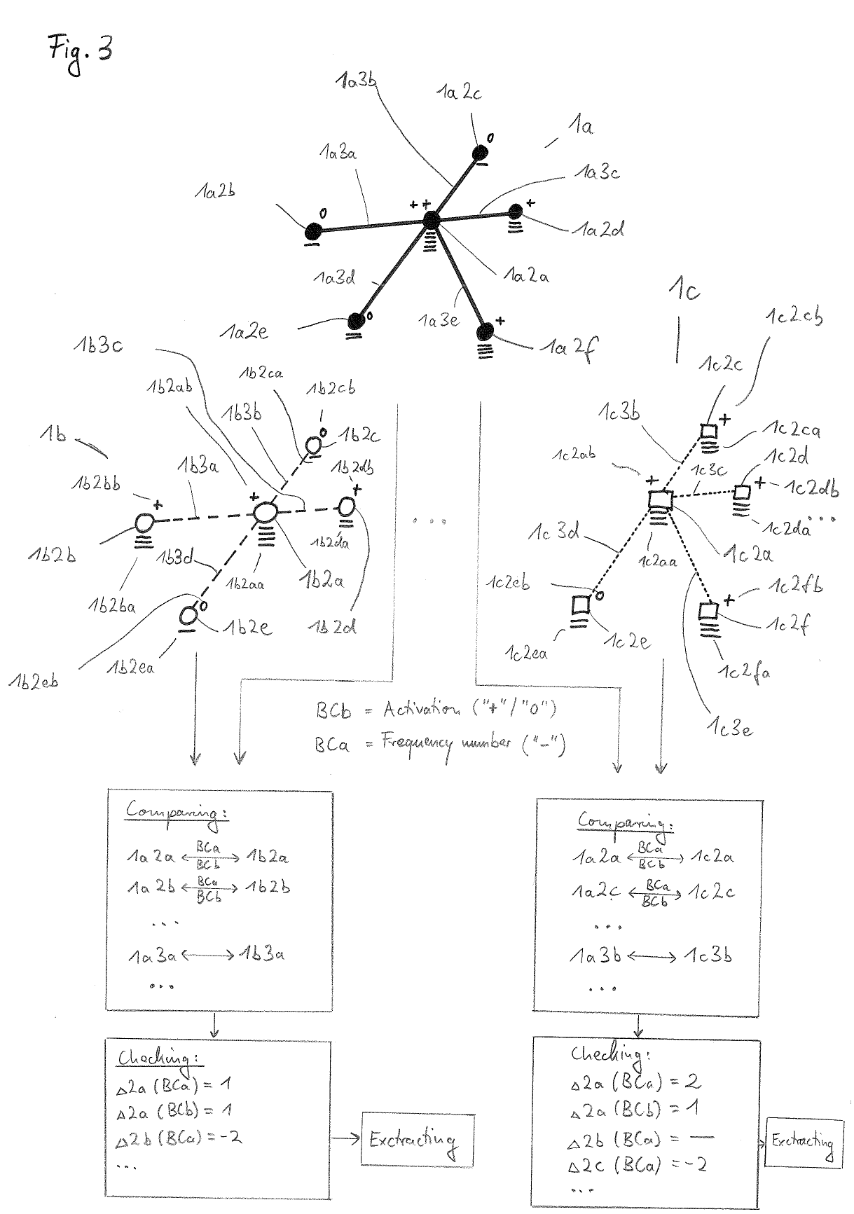

Since the reference graph 1a has been defined and generated in phase 300 (see FIG. 2), the next phase 310 is the comparison of the reference graph 1a with a second graph 1b (see FIG. 3). The second graph 1b comprises five nodes 1b2a to 1b2e and four edges 1b3a to 1b3d. Each one of the nodes 1b2a to 1b2e comprises, similar to the reference graph 1a, a specific frequency number 1b2aa to 1b2ea and activation information 1b2ab to 1b2eb. It is clear that such properties can also be associated with the edges 1b3a to 1b3d of the second graph 1b. Similar to the reference graph 1a, the second graph 1b represents at least a portion of a second information source 100b. The second information source 100b can be a second electronic text document 100b.

The second graph 1b can be generated from at least a portion of a second information source 100b as described in detail in the co-pending U.S. patent application Ser. No. ______ (Attorney Docket No. 4280-121) filed in the name of Martin Christian Hirsch, and entitled “SEMANTIC PARSER.” The same aspects relate to the generation of a further graph 1c from at least a portion of a further information source 100c of the plurality of information sources 100.

In detail, the comparison between the reference graph 1a and the second graph 1b is a comparison between similar or identical nodes, i.e. between nodes (e.g. 1a2a with 1b2a, 1a2b with 1b2b, etc.), that correspond to identical or similar information elements 110 which appear both in the reference information source 100a and the second information source 100b. The same aspect can relate to corresponding edges (e.g. 1a3a with 1b3a, etc.) of the reference graph 1a and the second graph 1b.

The comparison between the reference graph 1a and the second graph 1b is performed using at least one extraction criterion. The extraction criterion comprises at least one extraction criterion boundary value. With regard to the example as shown in FIG. 3, two extraction criteria are defined and used. It should, however, be noted that these two extraction criteria are merely exemplary and are not limiting of the invention. The first one of the extraction criteria BCa is the frequency number extraction criterion BCa. The second one of the extraction criteria BCb is the activation information extraction criterion BCb. For each one of the criteria, a boundary value or a boundary interval can be specified or set by a user. According to a further aspect of the invention, the extraction criterion and/or the boundary value or interval of the extraction criterion can be adapted. Such an adaptation can be dynamic in dependence of the characteristics (structural layout and/or status) of the reference graph 1a and/or the second graph 1b. According to a further aspect of the invention, such an adaptation can be performed in real-time by a user.

The comparison of the reference graph 1a with the second graph 1b using the above described extraction criteria BCa, BCb and, if required, further extraction criteria can produce a result that comprises, for example, the number of identical nodes (1a2a-1b2a), (1a2b-1b2b), (1a2c-1b2c), (1a2d-1b2d), (1a2e-1b2e) and the nodes apart between the reference graph 1a and the second graph 1b. Further, the result can comprise the number of the nodes and the nodes apart, i.e. the identification of the nodes which are not identical or contained in both of the two compared graphs 1a, 1b (here: node 1a2f of the reference graph 1a is not contained in the second graph 1b). Next, the result can comprise a difference, i.e. a delta of between the frequency number of the one node of the reference graph 1a and the frequency number of the corresponding node of the second graph 1b. For example, the first node 1a2a of the reference graph 1a has or is associated with a frequency number 1a2aa of five (see FIGS. 1 and 3). The first node 1b2a of the second graph 1b that has been detected similar or identical to the first node 1a2a of the reference graph 1a has or is associated with a frequency number 1b2aa of four. Further, the result can comprise information about a difference in activation information. With regard to FIGS. 1 and 3 the first node 1a2a of the reference graph 1a is activated two times (marked with two “+”), i.e. the first activation information 1a2ab comprises two counters representing an activated status. The first node 1b1a of the second graph 1b which is, as already mentioned, identical or similar to the first node 1a2a of the reference graph 1a (they correspond to identical or similar information elements 110 in both the reference information source 100a and the second information source 100b) comprises an activation information according to which the first node 1b2a is merely activated one time (marked with one “+”), i.e. the first activation information 1b2ab comprises one counter representing an activated status. The same aspects are also relevant for the comparison of the remaining nodes 1a2b to 1a2f, 1b2b to 1b2e and/or edges 1a3a to 1a3e, 1b3a to 1b3d. With regard to the example as shown in FIG. 3 the relevant nodes and/or edges from the reference graph 1a and the second graph 1b are compared with regard to the extraction criterion BCa, i.e. the frequency number, and with regard to the extraction criterion BCb, i.e. the activation information. In case of the frequency number and/or the activation information (represented with “+” counters if the node is activated and represented with “0” counters if the node is in a deactivated, i.e. passive status), a difference value or difference values as the result or results of the comparison can be determined between corresponding nodes.

In phase 320 (see FIGS. 2 and 3) the result of the comparison between the reference graph 1a and the second graph 1b, i.e. the nodes and/or the edges, is checked if the result falls within at least one extraction criterion boundary value. With regard to the example as shown in FIG. 3 and the above described difference values, the method can determine (with a specific probability) if the second graph 1b representing at least a portion of a second information source 100b is relevant or appears similar to the reference graph 1a.

With regard to the frequency numbers 1a2aa to 1a2fa, 1b2aa to 1b2ea and/or the activation information 1a2ab to 1a2fb, 1b2ab to 1b2eb of the nodes 1a2a to la2f, 1b2a to 1b2e the corresponding difference values can be analyzed and checked whether a specific boundary value or interval is fulfilled or not. With regard to the first node 1a2a of the reference graph 1a which is similar or identical to the first node 1b2a of the second graph 1b, the result, i.e. the difference value Δ2a(BCa), concerning the frequency number extraction criterion and/or the result, i.e. the difference value Δ2a(BCb), concerning the activation information extraction criterion is checked whether they lie in a specific boundary value interval or not, i.e. whether they underlie or overlie a specific boundary value or not. The result of such a checking leads to information that represents the relevance of the second graph 1b with regard to the reference graph 1a. The more compared nodes and/or compared edges are identical then the second graph 1b is more identical or similar to the reference graph 1a. If the checked results of the comparison falls at least within the at least one extraction criterion boundary value then the checked results can be extracted. The extracted checked results and/or the second information sources 100b or a link to the second information source 100b may then be collected, i.e. stored and/or displayed.

In phase 340 (see FIG. 2) the comparison of the (defined) reference graph 1a is continued with a further graph 1c (see FIG. 3). The further graph 1c comprises five nodes 1c2a, 1c2c to 1c2f and four edges 1c3b to 1c3e. Each one of the nodes 1c2a, 1c2c to 1c2f comprises, similar to the reference graph 1a or the second graph 1b, a specific frequency number 1c2aa, 1c2ca to 1c2fa and activation information 1c2ab, 1c2cb to 1c2fb. It is clear that such properties can also be associated with the edges 1c3b to 1c3e of the further graph 1c. Similar to the reference graph 1a and/or the second graph 1b, the further graph 1c represents at least a portion of a further information source 100c. The further information source 100c can be a further electronic text document 100c.

With regard to the comparison of the reference graph 1a with the second graph 1b, the same aspect can be performed for the further graph 1c, i.e. the phases 310, 320 and 330 can be repeated with the reference graph 1a and the further graph 1c.

The method is finished until all the remaining available information sources 100 are compared with the reference information source 100a represented by graphs 1a, 1b, 1c. According to a further aspect of the invention, the method can be stopped using a stop criterion. Such a stop criterion may be, for example, the number of information sources and/or graphs that are compared with the reference information source 100a, i.e. the reference graph 1a.

The method according to the invention can compare graphs of n-order, for example, of first-order. In one aspect of the invention, the method can compare k-graphs.

Since the method is a computer implemented method, each graph 1a, 1b, 1c can be represented as a matrix. Following, the comparison and checking can be performed using known matrix operation strategies.

FIG. 4 shows an example of a schematic representation of an apparatus 50 for performing the method according to the invention. The apparatus 50 can be, for example, an electronic data processing apparatus such as a personal computer, a server, a web-server, a terminal, a PDA, etc. with access to at least one electronic file, i.e. information source database and/or to a mobile communications network with access to electronic information sources such as downloadable text documents, web pages, etc.

According to a further aspect of the invention, the apparatus 50 can be a computer system comprising a crawler or a crawling engine. The crawler or the crawling engine can be a web crawler. The crawler can have programming code for performing the method according to the invention as previously discussed. In other words, the method according to the invention can be implemented in the crawler or the crawler engine to crawl through a plurality of information sources 100a-c, for example, on the Internet and/or in an Intranet in order to compare the relevance of the information source 100a-c with a subject of relevance (as defined by the reference graph 1a). Those ones of the information sources 100a-c having graphs falling within the extraction criterion boundary values are considered to be relevant to the subject of relevance and can be extracted for reference by a human user. A bot crawling through the Internet and/or the Intranet would perform the comparison of the reference graph 1a with the second graph 1b and report the uniform resource locator (URL) of those information sources 100 of relevance.

Further, the apparatus 50 can be a mobile communications device such as a mobile phone, a smart phone, etc. The apparatus 50 can also be, for example, part of a electronic data processing apparatus such as a server, personal computer, PDA, laptop, etc. or a mobile telephone or any kind of electronic apparatuses for communication or with access to a storage device or a communications network storing or providing one or more information sources as described above.

The apparatus 50 of FIG. 4 comprises at least one graph definition engine 51 for defining a reference graph 1a and generating a second graph 1b and/or a further graph 1c. As previously discussed, the reference graph 1a represents at least a portion of a reference one 100a of the plurality of information sources 100 and the second graph 1b represents at least a portion of a second one 100b of the plurality of information sources 100. Analogously, the further graph 1c represents at least a portion of a further one 100c of the plurality of information sources 100. It should further be noted that the reference graph 1a might be pre-defined from a previously analyzed plurality of information sources 100 or could be defined by a human researcher.

It is also conceivable that the reference graph 1a is dynamically changed during the crawl of the Internet and/or the Intranet as the reference graph 1a is adapted during the crawl to newly found information sources 100.

The apparatus 50 further includes at least one graph comparison and checking engine 52 for comparing the reference graph 1a with the second graph 1b and/or the further graph 1c and checking the result of the comparison. The apparatus 50 comprises further at least one graph information extraction engine 53 for extracting the checked result of the comparison.

Furthermore the apparatus 50 is connected to an output device 54 for presenting and displaying the graphs and/or the extracted information.

The apparatus 50 of FIG. 4 is further connected to data input devices such as a keyboard 61, a pointing device (e.g. a computer mouse) 60, etc. The apparatus 50 may further be connected to an external database 70 storing, for example the reference information source 100a. The external database 70 may be connected directly to the apparatus 50. Further databases 71, 72, storing, for example, the second and the further information sources 100b, 100c, may be accessible via a communications network such as the Internet to the apparatus 50. The apparatus 50 may be in hardware and/or software. Since the apparatus 50 is a computer it may further comprise, for example, a cd-rom/DVD drive, a floppy drive, a hard drive, a disk controller, a ROM memory, a RAM memory, communication ports, a central processing unit, etc.

Since the invention has been described in terms of single examples, the man skilled in the art will recognize that the invention can be practiced with modification within the spirit and scope of the attached claims.

At least, it should be noted that the invention is not limited to the detailed description of the invention and/or of the examples of the invention. It is clear for the person skilled in the art that the invention can be realized at least partially in hardware and/or software and can be transferred to several physical devices or products. The invention can be transferred to at least one computer program product. Further, the invention may be realized with several devices.

What is claimed is:

1. A method for extraction of information from a plurality of information sources, each ones of the plurality of information sources comprising at least one first information element being associated with at least one second information element, the method comprising:
defining a reference graph, the reference graph representing at least a portion of a reference one of the plurality of information sources, the reference graph having at least one first reference node representing the at least one first information element being associated with at least one second reference node via at least one edge, the at least one second reference node representing the at least one second information element, the at least one first reference node comprising at least one first reference node property value; the at least one second reference node comprising at least one second reference node property value;
comparing the defined reference graph with a second graph, the second graph representing at least a portion of a second one of the plurality of information sources using at least one extraction criterion, the at least one extraction criterion comprising at least one extraction criterion boundary value;
checking the result of the comparison of the defined reference graph with the second graph if the result falls within the at least one extraction criterion boundary value; and
extracting the checked result of the comparison if the checked result falls at least within the at least one extraction criterion boundary value.

2. The method according to claim 1, wherein the at least one edge is associated with at least one first edge property value.

3. The method according to claim 1, wherein the at least one extraction criterion boundary value is in relation with the at least one second reference node property value.

4. The method according to claim 1, further comprising:
continuing the comparison of the defined reference graph with a further graph and checking of the result of the comparison, the further graph representing at least a portion of a further one of the plurality of information sources.

5. The method according to claim 1, wherein the at least one first reference node property value comprises a frequency number.

6. The method according to claim 1, wherein the at least one first reference node property value comprises activation information.

7. The method according to claim 1, wherein the method is a computer implemented process.

8. An apparatus for extraction of information from a plurality of information sources, the apparatus comprising:
at least one graph definition engine for defining a reference graph and generating a second graph, the reference graph representing at least a portion of a reference one of the plurality of information sources and the second graph representing at least a portion of a second one of the plurality of information sources
at least one graph comparison and checking engine for comparing the reference graph with the second graph and checking the result of the comparison; and
at least one graph information extraction engine for extracting the checked result of the comparison.

9. The apparatus according to claim 8, further comprising:
at least one output device for presenting the extracted checked result of the comparison.

10. A computer system comprising:
a crawler comprising programming code for extraction of information from a plurality of information sources, each ones of the plurality of information sources comprising at least one first information element being associated with at least one second information element, the method comprising:
defining a reference graph, the reference graph representing at least a portion of a reference one of the plurality of information sources, the reference graph having at least one first reference node representing the at least one first information element being associated with at least one second reference node via at least one edge, the at least one second reference node representing the at least one second information element, the at least one first reference node comprising at least one first reference node property value; the at least one second reference node comprising at least one second reference node property value;
comparing the defined reference graph with a second graph, the second graph representing at least a portion of a second one of the plurality of information sources using at least one extraction criterion, the at least one extraction criterion comprising at least one extraction criterion boundary value;
checking the result of the comparison of the defined reference graph with the second graph if the result falls within the at least one extraction criterion boundary value; and
extracting the checked result of the comparison if the checked result falls at least within the at least one extraction criterion boundary value.

11. A computer readable tangible medium storing instructions for implementing a process driven by a computer, the instructions controlling the computer to perform the process of extraction of information from a plurality of information sources, each ones of the plurality of information sources comprising at least one first information element being associated with at least one second information element, the extraction of information comprising:
defining a reference graph, the reference graph representing at least a portion of a reference one of the plurality of information sources, the reference graph having at least one first reference node representing the at least one first information element (110aa) being associated with at least one second reference node via at least one edge, the at least one second reference node representing the at least one second information element, the at least one first reference node comprising at least one first reference node property value; the at least one second reference node comprising at least one second reference node property value;
comparing the defined reference graph with a second graph, the second graph representing at least a portion of a second one of the plurality of information sources using at least one extraction criterion, the at least one extraction criterion comprising at least one extraction criterion boundary value;
checking the result of the comparison of the defined reference graph with the second graph if the result falls within the at least one extraction criterion boundary value; and
extracting the checked result of the comparison if the checked result falls at least within the at least one extraction criterion boundary value.

12. A computer program product, being loadable into at least one memory of a computer readable tangible medium or into an electronic data processing apparatus, the computer program product comprising program code means to perform extraction of information from a plurality of information sources, each ones of the plurality of information sources comprising at least one first information element being associated with at least one second information element, the extraction of information comprising:
defining a reference graph, the reference graph representing at least a portion of a reference one of the plurality of information sources, the reference graph having at least one first reference node representing the at least one first information element being associated with at least one second reference node via at least one edge, the at least one second reference node representing the at least one second information element, the at least one first reference node comprising at least one first reference node property value; the at least one second reference node comprising at least one second reference node property value;
comparing the defined reference graph with a second graph, the second graph representing at least a portion of a second one of the plurality of information sources using at least one extraction criterion, the at least one extraction criterion comprising at least one extraction criterion boundary value;
checking the result of the comparison of the defined reference graph with the second graph if the result falls within the at least one extraction criterion boundary value; and
extracting the checked result of the comparison if the checked result falls at least within the at least one extraction criterion boundary value.

13. The computer program product of claim 12, wherein the program code means are executed on the computer readable tangible medium or on the electronic data processing apparatus.
